(19) United States
(12) Patent Application Publication
(10) Pub. No.: US 2026/0200949 A1
(43) Pub. Date: Jul. 16, 2026

(54) IMPROVED PROCESS FOR PREPARING METAL ALKOXIDE COMPOUNDS

(71) Applicant: EVONIK OPERATIONS GMBH, Essen (DE)

(72) Inventors: Moritz SCHRÖDER, Münster (DE); David HARDING, Dorsten (DE); Christoph HILLER, Dülmen (DE); Niklas PAUL, Marl (DE); Philip ZITZEWITZ, Haltern am See (DE)

(73) Assignee: EVONIK OPERATIONS GMBH, DE (DE)

(21) Appl. No.: 19/135,454

(22) PCT Filed: Nov. 28, 2023
(86) PCT No.: PCT/EP2023/083282

§ 371 Date: Jun. 4, 2025

(30) Foreign Application Priority Data
Dec. 7, 2022 (WO) PCT/EP2022/084746

(51) Int. Cl. C07F 1/00

(52) U.S. Cl. CPC C07F 1/005

(57) ABSTRACT

The present invention relates to a process for preparing metal alkoxide compounds, especially metal alkoxides, in a reactive distillation column. This is notable for an advantageous way of processing the vapour obtained, which gives a condensate of the vapour that can be used in an energy-efficient manner, for example for thermal integration into the same processes or external processes. The process according to the invention is used in particular for transalcoholization.

The present invention relates to a process for preparing metal alkoxide compounds, especially metal alkoxides, in a reactive distillation column. This is notable for an advantageous way of processing the vapour obtained, which gives a condensate of the vapour that can be used in an energy-efficient manner, for example for thermal integration into the same process or external processes. The process according to the invention is used in particular for transalcoholization.

### BACKGROUND OF THE INVENTION

Alkali metal alkoxides are used as strong bases in the synthesis of numerous chemicals, for example in the production of pharmaceutical or agrochemical active ingredients. Alkali metal alkoxides are also used as catalysts in transesterification and amidation reactions.

Alkali metal alkoxides are prepared by electrolysis, for example, as described in EP 3 885 470 A1.

Alkali metal alkoxides (MOR) are additionally also produced by reactive distillation of alkali metal hydroxides (MOH) and alcohols (ROH, e.g. methanol) in a countercurrent distillation column, wherein the water of reaction formed according to the following reaction <A> is removed with the distillate:

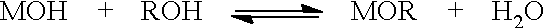

This “conventional” process principle (i.e. the production of alkali metal alkoxides from alkali metal hydroxides and the corresponding alcohol ROH by reactive distillation) is described, for example, in GB 737 453 A, U.S. Pat. Nos. 4,566,947 A, 2,877,274 A, EP 0 091 425 A2, DD 246 988 A1, WO 01/42178 A1, CN 109 627 145 A, CN 208632416 U, WO 2021/148174 A1 and WO 2021/148175 A1. This involves conducting aqueous alkali metal hydroxide solution and gaseous alcohol (for example methanol, ethanol, propanol or butanol) in countercurrent in at least one reactive distillation column. The most industrially important alkali metal alkoxides here are those of sodium and potassium, and here especially the methoxides and ethoxides. Their synthesis is frequently described in the prior art, for example in EP 1 997 794 A1.

Methods that are similar, but in which an entraining agent, for example benzene, is additionally used, are described in GB 377,631 A and U.S. Pat. No. 1,910,331 A. This entraining agent is used to separate water and the water-soluble alcohol. In both patent specifications the condensate is subjected to a phase separation to separate off the water of reaction.

Correspondingly, DE 96 89 03 C describes a method of continuous preparation of alkali metal alkoxides in a reaction column, wherein the water-alcohol mixture withdrawn at the top is condensed and then subjected to a phase separation. The aqueous phase is discarded and the alcoholic phase is returned to the top of the column together with the fresh alcohol. EP 0 299 577 A2 describes a similar method, wherein the water in the condensate is separated off with the aid of a membrane.

The syntheses of the alkali metal alkoxides from alkali metal hydroxides and the corresponding alcohol ROH by reactive distillation as described in the prior art typically afford vapours comprising the alcohol used and water. It is advantageous for economic reasons to reuse the alcohol present in the vapours as a reactant in the reactive distillation. The vapours are therefore typically fed to a rectification column and the alcohol present therein is separated off (described for example in EP 4 074 684 A1, EP 4 074 685 A1, WO 2021/148174 A1 and WO 2021/148175 A1). The alcohol thus recovered is then fed to the reactive distillation as a reactant.

A further means of preparing alkali metal alkoxides MOR′ is the reaction of an alkali metal alkoxide MOR with another alcohol R′OH. This “transalcoholization” is described, for example, in CS 213119 B1 and is advantageously conducted in a reaction column, as described in U.S. Pat. No. 3,418,383 A and DE 27 26 491 A1. It is effected according to the following reaction scheme <B>:

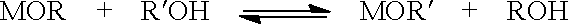

Typically, R′OH is an alcohol having a higher boiling point than ROH; for example, ROH=methanol, and R′OH is an alcohol having a longer alkyl chain (R′ is, for example, ethyl, propyl or butyl).

In addition, WO 2021/122702 A1 also describes a process for preparation of higher alkoxides by reactive distillation from lower alkoxides. According to reaction equation <B>, a metal alkoxide ROM (sodium methoxide) and an alcohol R′OH (iso-propanol, 2-butanol, 2-methyl-2-butanol) is converted in countercurrent in a reaction column having a stripping section and a rectifying section to the corresponding metal alkoxide R′OM and the alcohol ROH (methanol), by feeding alcohol R′OH into the bottom of the column and feeding ROM into the column via a lateral feed. At the bottom of the column, the corresponding alkoxide is obtained as target product R′OM, while the alcohol ROH (methanol) is drawn off as vapour at the top of the column. By contrast with the “conventional” procedure in which a methanol/water vapour is typically obtained, which is then directed as vapour into a rectification column and separated therein, the transalcoholization, as apparent from reaction equation <B>, does not give rise to water. Thus, the vapour obtained in a reaction column in the transalcoholization comprises ROH (typically methanol), which is advantageously condensed and removed from the process in liquid form. It is also advantageous to feed at least a portion of the vapour back to the column in condensed form as reflux, in order to increase the purity of the solution obtained in the bottom. Accordingly, the vapour of the alcohol ROH obtained at the top is partly condensed, and a portion of that condensate is then returned to the top of the column, while the remaining portion of the condensate is discharged from the process.

WO 2021/122702 A1 notes that this process features improved energy efficiency. A disadvantage arises, however, in the performance of this process, and in particular in the condensation of the vapour. This is because industrial condensers never condense the vapour down to its dewpoint, but typically subcool the condensate, and subcooling of the condensate in the region of 10 K is not unusual, as described, for example, by R. K. Shah, A. C. Müller, D. P. Sekulic in “Heat Exchangers, 3. Phase Change in Heat Exchanger Design”, Ullmann's Encyclopedia of Industrial Chemistry, 2014, 10.1002/14356007.t12_t02. The portion of the condensate discharged from the process according to WO 2021/122702 A1 is thus at a lower energy level than if it were in the liquid boiling state. This is disadvantageous since it becomes more difficult to utilize the residual energy stored in the condensate, especially the heat. Since the stream of the portion of the condensate discharged in the process according to WO 2021/122702 A1 is at a low temperature level, this restricts the options for use thereof as energy source. But such external or internal utilization of the energy is desirable in order to enable energy saving. Especially in the case of thermal integration into other streams, for example into one of the feed streams, there is thus less energy available in the process according to WO 2021/122702 A1.

It was thus an object of the present invention to provide a process for transalcoholization in a reaction column that does not have this disadvantage.

### BRIEF DESCRIPTION OF THE INVENTION

A process which achieves the object of the invention has now surprisingly been found.

The present invention thus relates to a process for preparing a compound of the formula MOR² by reactive distillation, wherein
a) a stream S₁ comprising a compound of the formula MOR¹ is fed via a lateral feed into a reactive distillation column RR with a rectifying section V above the feed point and a stripping section A below the feed point,
b) a stream S₂ comprising a compound of the formula R²OH is fed into the stripping section A, the bottom and/or a bottoms circuit of the column RR,
which affords, in the stripping section A, a crude product comprising MOR², R²OH and R¹OH, with or without MOR¹, and, in the rectifying section V, a vapour B₁ comprising R¹OH, with or without R²OH;
c) a stream S_{U} of a solution of MOR² in R²OH is drawn off at the bottom of the column RR and/or from the bottoms circuit;
d) the vapour B₁ is drawn off at the top of column RR as vapour stream S_{O} comprising R¹OH, vapour stream S_{O} is at least partly condensed, giving a condensate K_{O} at a temperature T_{KO}, and the whole condensate K_{O} is returned as reflux stream SKO to the rectifying section V, especially to the top, of column RR;
e) in the column RR, the condensate K_{O} is contacted with the vapour B₁, such that energy is transferred from the vapour B₁ to the condensate K_{O}, which affords a condensate K₁ comprising R¹OH at a temperature T_{K1}, where T_{KO}<T_{K1};
f) and at least a portion of K₁ is withdrawn from the rectifying section V below the feed of S_{KO} into RR as liquid sidestream S_{K1},
where M is a metal,
and where R¹ is an alkyl radical optionally having one or more hydroxyl groups, or a haloalkyl radical optionally having one or more hydroxyl groups,
and where R² is an alkyl radical optionally having one or more hydroxyl groups, or a haloalkyl radical optionally having one or more hydroxyl groups,
where, for R¹ and R², the carbon chain of the alkyl radical or haloalkyl radical may be interrupted by one or more oxygen atoms, where there are at least two carbon atoms between interrupting oxygen atoms and any hydroxyl group included in R¹ or R²,
and where R¹ and R² are different.

It is essential to the invention that T_{KO}<T_{K1}. This ensures that, rather than the subcooled condensate which is obtained in the prior art, a higher-energy sidestream K₁ is obtained. As a result, the sidestream K₁ is better suited for integration of energy, for example for preheating of streams in other processes or the process according to the invention. In particular, energy is transferred from sidestream K₁ to at least one of the reactant streams S₁ and S₂.

M here is especially an alkali metal, preferably selected from the group consisting of sodium, potassium, lithium, more preferably selected from the group consisting of sodium, potassium. Most preferably, M=sodium.

### FIGURES

FIG. 1 shows a noninventive embodiment based on the prior art process as described in WO 2021/122702 A1.

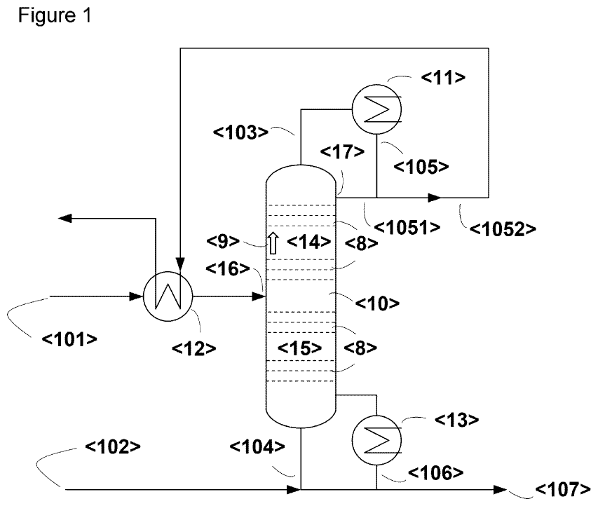

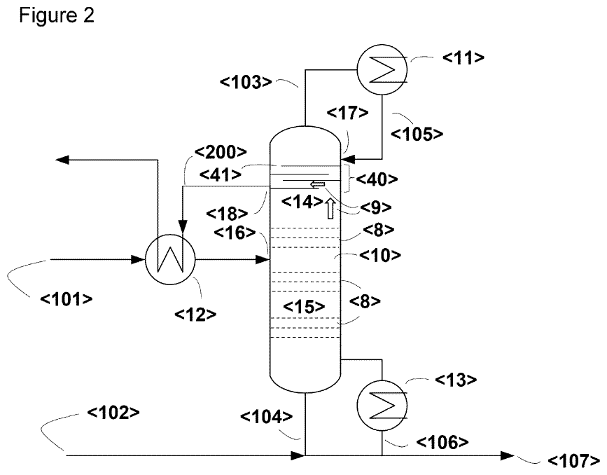

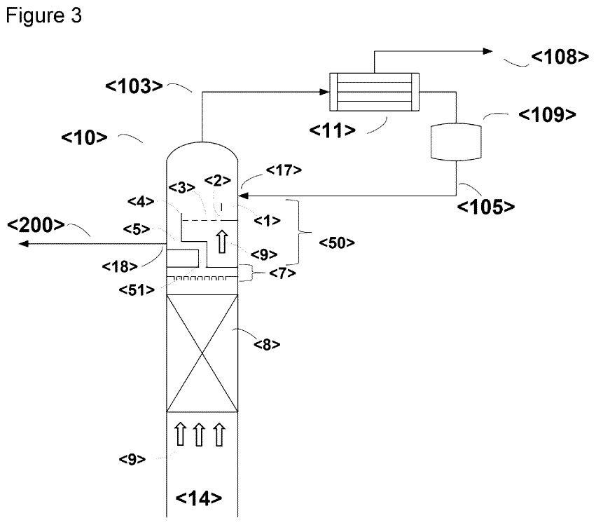

This involves directing a stream S₁<101> of a 30% by weight solution of sodium methoxide in methanol through a heat transferrer WT<12>, and feeding it at a feed point <16> into a reactive distillation column RR<10> that especially has trays and/or packings <8>. The column RR<10> has a rectifying section V<14> above the feed point <16> and a stripping section A<15> below the feed point <16>. In the bottoms circuit, a stream S₂<102> of ethanol is fed in. As a result, in the stripping section A<15>, a reaction mixture comprising ethanol, methanol, sodium ethoxide and optionally also sodium methoxide is obtained. At the bottom of the reaction column RR<10>, a solution of sodium ethoxide in ethanol is drawn off as bottom stream <104>, which is partly discharged from the process as stream S_{U}<107> and partly fed back into the reaction column RR <10> as part <106> of the bottoms circuit via an evaporator <13>. In WO 2021/122702 A1, stream S₂<102> is alternatively fed directly to the evaporator <13>. Accordingly, in the embodiment shown in FIG. 1 (and also in the inventive embodiment according to FIG. 2 of the present invention), stream S₂<102> may also alternatively or additionally be fed directly to the evaporator <13> or else to the portion <106> of the bottoms circuit. The bottoms circuit is formed by the combination of streams <104> and <106>.

The vapour B₁<9> obtained in the rectifying section V<14> comprises methanol. Since vapours are gaseous, it ascends in the direction of the top of the reaction column RR<100>, where it is drawn off as vapour stream S_{O}<103> comprising methanol. This is condensed in the condenser <11>, where the resultant condensate K_{O}<105> is at a temperature T_{KO} which, for technical reasons, is 1 to 20 K below the boiling temperature of the condensate K_{O}<105>. A portion <1051> of the condensate K_{O}<105> is returned at the feed point <17> to the top of the reaction column RR <100>, while the other portion <1052> of the condensate K_{O}<105> can be discharged from the process and used as energy source. It is preferable here that, as shown in FIG. 1, the portion <1052> is directed through WT<12>, while transferring energy, especially heat, to stream S₁<101>. This preheats stream S₁<101> before S₁<101> is fed into the reaction column RR<10> via the feed point <16>.

FIG. 2 shows one embodiment of the process according to the invention. It corresponds to the embodiment elucidated in FIG. 1 with the following differences:
1) The condensate K_{O}<105> is directed completely into the reaction column RR<10> at the feed point <17> as stream S_{KO}.
2) In column RR<10>, there is an apparatus <40> which permits contacting of the condensate K_{O}<105> directed into the column RR<10> as stream S_{KO} with the vapour B₁<9> ascending within the column RR<10>. This transfers energy from the vapours B₁<9> to at least a portion of the condensate K_{O}<105>, and heats at least a portion of the condensate K_{O}<105> to a temperature T_{K1} which is just below the boiling temperature of the condensate K_{O}<105> and in any case higher than T_{KO}. The condensate heated to the temperature T_{K1} is referred to as “K₁”. The apparatus <40> outlined in FIG. 2 is a possible preferred configuration of a setup of the reactive distillation column RR<10> such that the condensate K_{O}<105> returned to the rectifying section V<14>, especially to the top of RR<10>, as reflux stream SK_{O} in step (d) can be contacted with the vapour B_{1<9}> in such a way that, within the reactive distillation column RR<10>, energy is transferred from the vapours B_{1<9}> to at least a portion of K_{O}<105>, and then, in step (f), at least a portion of K_{O}<105> can be withdrawn from the rectifying section V<14> of the column RR<10> as liquid sidestream S_{K1}.
<40> comprises multiple trays <41> (or else alternatively packings) that are offset relative to one another, so as to result in a pathway in which the condensate K_{O}<105> and the vapour B₁<9> are guided in countercurrent. As a result, energy can be transferred from the vapour B₁<9> to the condensate K_{O}<105>, which results in heating thereof to the temperature T_{K1}. The trays <41> are, for example, bubble-cap trays or sieve trays.
3) At a withdrawal point <18>, the condensate K₁ that has then been heated with respect to K_{O}<105> is withdrawn as sidestream S_{K1}<200>. The feed point <18> is between the two feed points <16> and <17>. S_{K1}<200> is at a higher temperature than the substream <1051> of the condensate K_{O}<105> withdrawn in the noninventive embodiment (FIG. 1). Thus, S_{K1}<200> has higher energy and can be used in various ways for transfer of its energy. A preferred option is likewise shown in FIG. 2. Here, the energy from stream S_{K1}<200> is transferred via the heat transferrer WT<12> to the reactant stream S₁<101>, resulting in an increase in the energy efficiency of the process according to the invention. Alternatively or additionally, the energy from stream S_{K1}<200> can be transferred via a heat transferrer to the reactant stream S₂<102> (not shown in FIG. 2).

FIG. 3 shows a further preferred embodiment of the process according to the invention, in the form of apparatus <50> in particular, an alternative preferred configuration of a setup of the reactive distillation column RR<10> such that the condensate K_{O}<105> returned to the rectifying section V<14>, especially to the top of RR<10>, as reflux stream S_{K0} in step (d) can be contacted with the vapour B₁<9> in such a way that, within the reactive distillation column RR<10>, energy is transferred from the vapours B₁<9> to at least a portion of K_{O}<105>, and then, in step (f), at least a portion of K_{O}<105> can be withdrawn from the rectifying section V<14> of the column RR <10> as liquid sidestream S_{K1}<200>.

What is shown is the upper portion of a reactive distillation column RR<10>, i.e. from the rectifying section V<14> upward.

The vapour stream S_{O}<103> is condensed in condenser <11>, and an offgas stream <108> is led off during the condensation. The condensate K_{O}<105> is collected in the distillate vessel <109>.

The apparatus <50> according to FIG. 3 is constructed as follows: The stream S_{K1} of the condensate K_{O}<105> directed into the column via the feed point <17> is first collected in a shaft <1>. It flows via an opening <2> from the shaft <1> onto a tray <3> (for example a sieve tray or bubble-cap tray), such that the vapour B₁<9> flowing in from the bottom via the liquid distributor <7> makes contact with and heats the condensate K_{O}<105>. As a result of the constant inflow of the condensate K_{O}<105> into the region of the tray <3> and the vortices that arise from the contact of the condensate K_{O}<105> with the vapour B₁<9> flowing upward, K_{O}<105> flows over the edge <4> into a downcomer <5>, from which at least a portion of the condensate K₁ that has then been heated is removed as stream S_{K1}<200>. Excess condensate K₁ can be led off into the column RR<10> via conduit <51> and fed to the liquid distributor <7>. In the embodiment according to FIG. 3, the rectifying section <14> comprises packings <8>.

### DETAILED DESCRIPTION OF THE INVENTION

The present invention relates to a process for preparing a compound of the formula MOR² by reactive distillation.

The chemical reaction that forms the basis of the process according to the invention corresponds to the following reaction <C>:

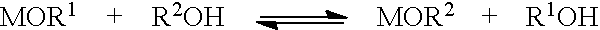

In the process according to the invention, the organic radical R¹O⁻ in MOR¹ is thus exchanged for the R²O⁻ radical, and MOR² is obtained.

R¹ is an alkyl radical or haloalkyl radical that optionally has one or more hydroxyl groups, where, for R¹, the carbon chain of the alkyl radical or haloalkyl radical may be interrupted by one or more oxygen atoms, where there are at least two carbon atoms between interrupting oxygen atoms and any hydroxyl group included in R¹.

R² is an alkyl radical or haloalkyl radical that optionally has one or more hydroxyl groups, where, for R², the carbon chain of the alkyl radical or haloalkyl radical may be interrupted by one or more oxygen atoms, where there are at least two carbon atoms between interrupting oxygen atoms and any hydroxyl group included in R².

R¹ and R² are different. The person skilled in the art will also appreciate that the compound R²OH will have a higher boiling point than R¹OH since this is a necessary prerequisite for R¹OH to be obtained at the top and R²OH at the bottom of column RR. This prerequisite is met automatically when R¹=methyl.

The compound of the formula MOR² is referred to in the context of the invention as “metal alkoxide compound”. “Metal alkoxide compound” in the context of the invention is especially understood to mean metal alkoxides and metal ether alkoxides. According to the invention, the metal alkoxide compound is preferably a metal alkoxide.

When the compound MOR² is a metal either alkoxide, R² is an alkyl radical interrupted by one or more oxygen atoms, where there are at least two carbon atoms between interrupting oxygen atoms and any hydroxyl group included in R², and where the alkyl group optionally has one or more hydroxyl groups.

When the compound MOR² is a metal alkoxide, R² is an alkyl radical optionally having one or more hydroxyl groups.

“Alkyl” in the context of the invention includes “cycloalkyl”.

“Haloalkyl” is preferably an alkyl radical in which at least one hydrogen atom has been exchanged for a halogen atom, where the halogen atom is more preferably selected from fluorine, chlorine.

In a preferred embodiment, R¹ is alkyl, more preferably C₁ to C₄-alkyl, even more preferably methyl or ethyl, and most preferably methyl.

More preferably, R¹ is methyl, and R² is selected from the group consisting of C₂ to C₁₀-alkyl, —(CH₂)₂OH, —(CH₂)₂O(CH₂)₂OH, —(CH₂)₃OH, —(CH₂)₄OH, 1-methoxypropan-2-yl.

Yet more preferably, R¹ is methyl, and R² is C₂ to C₁₀-alkyl. Yet more preferably, R¹ is methyl, and R² is selected from the group consisting of ethyl, iso-propyl, sec-butyl, 2-methyl-2-butyl, tert-butyl, 2-methyl-2-pentyl, 3-methyl-3-pentyl, 3-ethyl-3-pentyl, 2-methyl-2-hexyl, 3-methyl-3-hexyl.

Yet more preferably, R¹ is methyl, and R² is selected from the group consisting of ethyl, iso-propyl, sec-butyl, 2-methyl-2-butyl, 3-methyl-3-pentyl, 3-ethyl-3-pentyl.

Yet more preferably, R¹ is methyl, and R² is selected from the group consisting of ethyl, iso-propyl, 2-methyl-2-butyl.

Most preferably, R¹=methyl and R²=ethyl.

M is a metal, especially an alkali metal, preferably selected from lithium, sodium, potassium, more preferably from sodium, potassium.

Most preferably, M=sodium.

### Step (a)

In step (a) of the process according to the invention, a stream S₁ comprising a compound of the formula MOR¹ is fed via a lateral feed into a reactive distillation column RR with a rectifying section V above the feed point and a stripping section A below the feed point.

The word “lateral” is understood to mean that the feed is below the top of the column and above the bottom of the column. The feed point of stream S₁ divides the column into a rectifying section V (above the feed point) and a stripping section A (below the feed point).

The reaction corresponding to the aforementioned reaction <C> takes place in the stripping section A of the reaction column RR. If the stream S₁ is directed into the reaction column RR via multiple feed points, the rectifying section V is above the feed point closest to the top of the column RR, and the stripping section A is below the feed point closest to the top of the column RR.

According to the invention, “reactive distillation column” (synonym: “reactive rectification column”) defines a distillation column in which the reaction according to the invention as per the above reaction equation <C> proceeds at least in some parts. It can also be abbreviated to “reaction column” or, in the context of the present invention, to “column”.

The reactive distillation column RR used may be a standard reactive distillation column. The column RR is selected, for example, from columns with random packing, columns with structured packing and tray columns, more preferably tray columns and columns with structured packing.

Installed in suitable tray columns are sieve trays, bubble-cap trays or valve trays, through which the liquid phase flows. The reactive distillation column in the process according to the invention preferably has trays as internals, for example selected from bubble-cap trays, valve trays, tunnel trays, cross-slit bubble-cap trays, sieve trays, Thormann@trays.

Columns with random packing may be filled with different random packings. Heat and mass transfer are improved by the increase in the surface area on account of the shaped bodies that are usually about 25 to 80 mm in size. Known examples are the Raschig ring (a hollow cylinder), Pall ring, Hiflow ring, Intalox saddle and the like. The random packings may be introduced into the column in an ordered manner or else randomly (as a bed). Useful materials include glass, ceramic, metal and plastics.

Structured packings are a further development of the ordered random packings. They have a regular-shaped structure. It is thus possible in the case of structured packings to reduce pressure drops in the flow of gas. There are various designs of structured packings, for example fabric packings or sheet metal packings. The rectifying section of the column preferably comprises structured packings, while the stripping section of the column comprises trays.

The top of the column refers to the region free of internals above the uppermost tray, or above the uppermost layer of structured packing. It is generally formed by a curved plate (hood, e.g. dished end or torispherical head), which forms the concluding element of the reactive distillation column. According to the invention, the top of the column RR is also part of the rectifying section V.

The bottom of the column refers to the region free of internals below the lowermost tray, or below the lowermost layer of structured packing. According to the invention, the bottom of the column RR is also part of the stripping section A.

The suitable number of theoretical plates in the rectifying section depends on the difference between the vapour pressures of R¹OH and R²OH, with a greater number of theoretical plates being advantageous in the case of a smaller difference. The suitable number of theoretical plates in the stripping section depends on the difference between the vapour pressures of R¹OH and R²OH and the equilibrium position of the reaction, where a higher number of theoretical plates is advantageous the further the equilibrium lies to the reactant side. The suitable number of theoretical plates both in the rectifying section and in the stripping section also depends on the purity of bottom product and top product which is to be achieved, and the reflux rate used, where a higher number of theoretical plates is required to achieve a higher purity for a given reflux rate.

The column may consist of a multitude of individual vessels or individual columns arranged successively as a cascade. The individual vessels or individual columns are preferably arranged one on top of another and may optionally be laterally offset relative to one another. In a further embodiment, the individual vessels or individual columns are arranged alongside one another with use of suitable pump devices.

In both cases, it has to be ensured by means of corresponding connecting conduits and optionally transport devices that stripping section A and rectifying section V are coupled directly to one another, and the reflux of the rectifying section V can have an advantageous effect on the reaction that takes place in the stripping section A according to the above equation <C>. Preferably, the stripping section A (as reaction section) and the rectifying section V are arranged one on top of the other in a single column.

Stream S₁ is typically liquid.

In particular, stream S₁ is fed to the column RR as a solution of compound MOR¹ in compound R¹OH.

This solution then preferably contains 10% to 40% by weight of compound MOR¹, more preferably 18% to 35% by weight of compound MOR¹, yet more preferably 28% to 32% by weight of compound MOR¹, based on the total weight of the solution of compound MOR¹.

The temperature of this solution of compound MOR¹ in compound R¹OH at the lateral feed is suitably chosen such that compound MOR¹ always remains in solution. The temperature of stream S₁ is then preferably at least 6° C., especially at least 10° C. and more preferably at least 20° C., for example 25° C. or 30° C. Stream S₁ can be preheated up to boiling temperature, for example in a heat exchanger WT in which at least a portion of stream S_{U} drawn up at the bottom of the column is cooled down simultaneously. This is particularly advantageous in terms of energy.

In a further, more preferred embodiment of the present invention, in step (g), energy is transferred from S_{K1} to stream S₁. This transfer is especially effected by means of a heat exchanger WT for preheating of stream S₁. This further increases the energy efficiency of the process according to the invention.

Even though compound R²OH is added according to step (b) in the process according to the invention, stream S₁ may, as well as compound MOR¹, also comprise a portion of compound R²OH used in the process according to the invention. This means that, in one embodiment of the present invention, stream S₁ comprises a compound of the formula MOR¹ and R²OH.

Advantageously, however, compound R²OH is fed to the reaction column RR exclusively via stream S₂ in step (b). Thus, in a preferred embodiment of the present invention, the proportion of all compounds R²OH in stream S₁ is <10% by weight, more preferably <5% by weight, even more preferably <1% by weight, yet more preferably <0.1% by weight, yet more preferably <0.01% by weight, yet more preferably <0.001% by weight, yet more preferably <0.0001% by weight, based in each case on the total weight of stream S₁.

### Step (b)

In step (b) of the process according to the invention, a stream S₂ comprising a compound of the formula R²OH is fed into the stripping section A, the bottom and/or a bottoms circuit of the column RR.

In step (b), stream S₂ may be fed in liquid form or gaseous form into the stripping section A, the bottom or the bottoms circuit of column RR. Preferably, in step (b), stream S₂ is fed in liquid form into the stripping section A, the bottom and/or the bottoms circuit of column RR. More preferably, in step (b), stream S₂ is fed in liquid form into the bottom and/or bottoms circuit, especially the bottoms circuit, of column RR.

“Bottoms circuit” is understood to mean the portion of the bottom stream withdrawn from column RR which is fed back into column RR. In FIG. 2, the bottoms circuit is thus formed by streams <104> and <106>. This recycled portion of the bottom stream (in FIG. 2: <106>) is preferably heated by means of a forced-circulation evaporator (in FIG. 2: <13>) before being fed back into column RR.

The feeding of S₂ into the bottoms circuit can accordingly be effected into the bottom stream before stream S_{U} and the stream recycled as bottoms circuit are separated from one another (as shown in FIG. 2).

Alternatively, the feeding of S₂ into the bottoms circuit can be effected after the stream recycled as bottoms circuit and stream S_{U} have been separated from one another. If a forced-circulation evaporator is used, S₂ can also be fed into the forced-circulation evaporator.

In the process according to the invention, stream S₁ added in step (a) and stream S₂ added in step (b) may be conducted in countercurrent to one another in the stripping section. In column RR, a gas phase and a liquid phase are in contact with one another, and the equilibrium according to reaction equation <C> is established. In the stripping section A, a crude product comprising MOR², R²OH and R¹OH, with or without MOR¹, is obtained.

At the same time, the more volatile components become enriched in the gas phase in the direction of the top of column RR, and the less volatile components in the liquid phase in the direction of the bottom of the column.

A portion of compound R¹OH is thus in gaseous form in the reactive distillation column RR and ascends as vapour B₁ in the direction of the top of column RR. As a result, a vapour B₁ comprising R¹OH is obtained in the rectifying section V. This is drawn off at the top of column RR in step (d) of the process according to the invention as vapour stream S_{O} comprising R¹OH.

### Step (c)

In step (c) of the process according to the invention, a stream S_{U} of a solution of MOR² in R²OH is drawn off at the bottom of the column RR and/or from the bottoms circuit.

The stream S_{U} drawn off at the bottom of the column RR and/or from the bottoms circuit typically consists essentially of R²OH and the MOR². Stream S_{U} can therefore be used further as it is, optionally after cooling in a heat exchanger.

Alternatively, R²OH can be separated from MOR². This can be effected by evaporative concentration.

The solution of MOR² in R²OH drawn off as stream S_{U} advantageously includes only a small amount of compound R¹OH, which permits an efficient process. Preferably, the proportion of all compounds R¹OH in the solution drawn off as stream S_{U} is not more than 1.0% by weight, preferably not more than 0.5% by weight, more preferably not more than 0.3% by weight, even more preferably <0.01% by weight, yet more preferably <0.001% by weight, for example 0.001% to 0.20% by weight or 0.01% to 0.10% by weight, based on the total weight of the solution drawn off as stream S_{U}.

If R¹=methyl, the methanol concentration in the solution can be determined, for example, by vapour space analysis or by gas chromatography, as described in WO 2021/122702 A1.

The proportion of all compounds of the formula MOR² in the solution drawn off as stream S_{U} is especially in the range of 3% to 60% by weight, preferably 5% to 55% by weight and more preferably 7% to 50% by weight, for example 7% to 30% by weight, 15% to 25% by weight, 19% to 25% by weight or 21% to 24% by weight, based on the total weight of the solution drawn off as stream S_{U}.

According to the concentration of compounds MOR² and R²OH in stream S_{U}, stream S₂ can also be used to dilute stream S_{U}. Then, in step (b), stream S₂ is fed into the bottom stream in the bottoms circuit of the column before the bottom stream is divided into the bottoms circuit (identified as “<106>” in FIG. 2), which is directed to the evaporator, and a portion S_{U} (identified as “<107>” in FIG. 2), which is discharged from the process.

The concentration of the compounds of the formula MOR² in the solution drawn off as stream S_{U} can be determined, for example, by titration, as described in WO 2021/122702 A1.

The reactive distillation column RR typically has an evaporator. This evaporator may be integrated in the column bottom. But it is preferably an evaporator accommodated in the bottoms circuit (=“circulation evaporator” or “forced-circulation evaporator”). In this case, in particular, a substream of the stream drawn of at the bottom of the column is fed to the bottoms circuit and then returned to the column as a heated, possibly biphasic fluid stream.

Alternatively or additionally, the bottoms are heated directly.

Suitable evaporators are, for example, boilers, natural-circulation evaporators, forced-circulation evaporators and forced-circulation flash evaporators.

In the case of forced-circulation evaporators, a pump is used to conduct the liquid to be evaporated through the heater. The resultant vapour/liquid mixture is then returned to the column.

In the case of forced-circulation flash evaporators, a pump is likewise used to conduct the liquid to be evaporated through the heater. A superheated liquid recycle stream is obtained, which is expanded into the bottom of the column. The pressure on the solution drawn off from column RR, which is returned to the column, is increased by superheating. The superheated recycle stream is expanded through a flow limiter. This results in superheating of the liquid above its boiling point in relation to the pressure within the column.

On passage of the superheated liquid through the flow limiter and reentry into the column, the liquid is evaporated abruptly. This abrupt evaporation proceeds with a considerable increase in volume and leads to acceleration of the fluid flow entering the column. Advantageously, the flow limiter is disposed immediately upstream of the reentry of the superheated liquid into the column, or even within it. The flow limiter used is preferably a diaphragm, a valve, a throttle, a perforated plate, a nozzle, a capillary or combinations thereof, especially a valve. For example, it is possible to use a rotary plug valve. It is particularly preferable when the opening characteristics of the flow limiter are adjustable. In this way, it is possible always to keep the pressure in the evaporator above the boiling pressure of the liquid, based on the pressure within the column, even in the case of changed flow rates, as can occur, for example, in startup and shutdown operations. It is advantageous that operating the evaporator by forced circulation or by forced-circulation flashing achieves an elevated flow rate of the liquid in the heating apparatus compared to operation with natural circulation, for example in the tube bundle of the heat exchanger. The elevated flow rate results in improved heat transfer between heat exchanger and heated liquid, which in turn contributes to avoidance of local superheating.

The pump to be used in the case of forced-circulation or forced-circulation flash evaporators is preferably disposed between the withdrawal conduit and the evaporator.

In a preferred embodiment of the process according to the invention, the reactive distillation column RR has a forced-circulation evaporator and stream S₂ is fed in liquid form into the feed to the forced-circulation evaporator.

Alternatively or additionally to the forced-circulation evaporator, the bottoms may be heated directly, for example by means of a boiler.

The bottom temperature of the reactive distillation column RR at a given pressure determines the concentration of the compound MOR² in the solution drawn off as stream S_{U} at the bottom of column RR or from the bottoms circuit. The temperature and hence the concentration are appropriately chosen such that compound MOR² always remains in solution in the bottoms. The bottom temperature is adjusted, for example, by means of an evaporator and/or direct heating of the bottoms.

The process according to the invention can be conducted either under standard pressure or under elevated or reduced pressure. It is advantageous to operate the reactive distillation column RR at a pressure of 0.2 to 10 bar absolute. The reactive distillation column RR is preferably operated at ambient pressure, for example 1 bar absolute.

The equilibrium position of the reaction is temperature-dependent in the preparation of some compounds MOR², especially the alkoxides. In these cases, high temperatures may advantageously result in a higher conversion. It may also be advantageous to conduct the process according to the invention under elevated pressure, for example at least 1.5 bar absolute, at least 2.5 bar absolute, or at least 5.0 bar absolute.

In other embodiments, it is advantageous to conduct the process under reduced pressure, for example within a range of 0.1 to 0.9 bar absolute, especially 0.3 to 0.75 bar absolute.

The process according to the invention can be performed either continuously or batchwise. The process according to the invention is preferably performed continuously. Within the reactive distillation column RR, constant mass transfer and the changing concentrations within the gas phase and the liquid phase result in constant readjustment of the reaction equilibrium, which enables a high conversion. On startup of the column, the reflux rate can be adjusted by feeding compound R¹OH to the top of the column, for example directly into the condenser, and then feeding it to column RR together with the condensate K_{O} in step (d), where the stripping section A and the bottom are filled with compound R²OH. In addition, compound R¹OH can be added to compound R²OH.

On attainment of the operating temperature, stream S₁ is then fed in. New compound R¹OH is formed constantly during the reaction.

In a further embodiment, the reactive distillation column RR is filled with R²OH prior to startup, and R²OH is at first also used as reflux. On attainment of the operating temperature, stream S₁ is then fed in.

### Step (d)

In step (d) of the process according to the invention, the vapour B₁ is drawn off at the top of column RR as vapour stream S_{O} comprising R¹OH, vapour stream S_{O} is at least partly condensed, giving a condensate K_{O} at a temperature T_{KO}, and the whole condensate K_{O} is returned as reflux stream S_{KO} to the rectifying section V, especially to the top, of column RR.

In step (d) of the process according to the invention, the vapour B₁ is accordingly first drawn off at the top of column RR as vapour stream S_{O} comprising R¹OH. This vapour stream S_{O} advantageously includes only small amounts of compounds R²OH.

The vapour stream S_{O} comprising R¹OH which is drawn off at the top of column RR is at least partly condensed, giving a condensate K_{O} (also referred to as “tops condensate”) at a temperature T_{KO}. The temperature T_{KO} of the condensate K_{O} is below the boiling temperature of K_{O} under the given conditions, i.e. K_{O} does not boil. The condensation is preferably effected in one or more series-connected plate or shell-and-tube condensers or air coolers. Preference is given to using air coolers or shell-and-tube condensers or combinations thereof. Depending on their design, the condensers can be cooled, for example, by means of air, cooling water or brine.

In a preferred embodiment, uncondensable components and offgases are removed from the vapour stream S_{O} while it is being condensed in step (d). This can be effected in a gas separator known to the person skilled in the art, for example as a condenser with additional offgas removal.

Preferably, vapour stream S_{O} is essentially fully condensed, for example to an extent of more than 98% by weight or more than 99% by weight, based on the total amount of the vapour stream S_{O} drawn up at the top of column RR.

The proportion of all compounds R²OH in condensate K_{O} is not more than 1.0% by weight, preferably not more than 0.8% by weight, more preferably not more than 0.6% by weight and most preferably not more than 0.5% by weight, based on the total weight of K_{O}.

The proportion of all compounds R²OH in condensate K₁ is not more than 1.0% by weight, preferably not more than 0.8% by weight, more preferably not more than 0.6% by weight and most preferably not more than 0.5% by weight, based on the total weight of K₁.

The concentration of all compounds R²OH in condensate K_{O} or in condensate K₁ can be determined, for example, by gas chromatography, as described in WO 2021/122702 A1.

According to the invention, and by contrast with the prior art processes, as described, for example, in WO 2021/122702 A1, the whole condensate K_{O} is recycled as return stream S_{KO} into the rectifying section V, especially to the top, of column RR. What is meant in accordance with the invention by “whole” condensate is at least 90% by weight, especially at least 95% by weight, preferably at least 98% by weight, even more preferably at least 99% by weight, of the vapour stream S_{O} condensed in step (d) or of the portion of the vapour stream S_{O} which is condensed in step (d).

The reflux stream S_{KO} is returned to the rectifying section V of column RR in step (d). The process according to the invention thus also encompasses the embodiments in which the return stream S_{KO} is fed in below the top of the column RR, provided that the withdrawal point for the liquid sidestream S_{K1} is even further down and even in the rectifying section V, i.e. above the feed point for stream S₁ into the reaction column RR. It is advantageous that the return stream S_{KO} in step (d) is fed into the top of the column RR.

This is a first step in order to resolve the described disadvantages of the prior art processes.

These are that, in practice, the temperature T_{KO} of the condensate K_{O} obtained in step d) is not just below the boiling temperature of the condensate K_{O} but typically 1 to 15 K lower, and in some cases even lower. This is attributable to the industrial conditions that efficient condensation typically entails in the condensers mentioned, specifically on an industrial and large industrial scale. Condensation just below the boiling temperature of the respective condensate K_{O} is economically and technically complex. This typically results in a correspondingly significantly subcooled condensate K_{O}. This is intrinsically disadvantageous since it has a lower energy level than if it had a temperature T_{KO} only just below its boiling point. But specifically in industrial plants, it is desirable to use the energy of the condensate K_{O}, for instance for integration into the same process or external processes. It is necessary here to have access to streams of maximum energy, i.e. streams at a maximum temperature. But this is problematic in the processes according to reaction equation <C>, in which the condensation of the vapour stream S_{O} should not be dispensed with and a liquid condensate K_{O} is thus obtained, since the problem of subcooling of the condensate stream will thus always occur.

This problem is solved in accordance with the invention in that, in a first step, the whole condensate K_{O} is returned as reflux stream S_{KO} to the rectifying section V, especially to the top, of column RR.

The second step then consists in step (e) described below.

### Step (e)

In step (e) of the process according to the invention, in column RR, the condensate K_{O} is contacted with the vapour B₁, such that energy is transferred from the vapour B₁ to the condensate K_{O}.

This gives a condensate K₁ comprising R¹OH at a temperature T_{K1}, where T_{KO}<T_{K1}. T_{K1} is simultaneously at or below the boiling point of K₁, preferably at the boiling point of K₁, where “boiling point of K₁” is understood to mean the temperature at which K₁ boils.

In step (e), accordingly, energy, especially heat, is transferred from the vapours B₁ to the condensate K_{O} in the rectifying section V of the column RR. This heats the condensate K_{O} to a temperature T_{K1}>T_{KO}.

This is possible since the vapours B₁ have a higher energy content than the subcooled condensate K_{O}, since it is of course the vapours B₁ that are then condensed in step (d).

The condensate K_{O} is preferably contacted with the vapour B₁ at the top or in the rectifying section V of the column RR, preferably in the rectifying section V of the column RR.

The corresponding setup of the column RR can be undertaken by the person skilled in the art in accordance with their knowledge in the art. In principle, the condensate K_{O} has to be contacted with the vapour B₁ such that the condensate K₁ is heated to the desired temperature T_{K1}. At the same time, it is necessary to ensure that not so much energy is transferred from the vapour B₁ to the condensate K_{O} that K_{O} is completely evaporated and converted to the gas phase (and hence itself becomes part of the vapour B₁). On the other hand, it is necessary to avoid complete condensation of the vapour B₁ itself.

In order to ensure the transfer of energy, especially heat, from the vapours B₁ to the condensate K_{O} according to step (e) and the withdrawal of the resultant condensate K₁ according to step (f), the reactive distillation column RR is set up such that the condensate K_{O} recycled in step (d) as reflux stream S_{KO} into the rectifying section V, especially to the top, of RR is contacted with the vapour B₁ such that, within the reactive distillation column RR, energy is transferred from the vapours to at least a portion of K_{O}, and at least a portion of K_{O} can then be withdrawn from the rectifying section V of the column RR as liquid sidestream K₁ in step (f).

In step (e), in a preferred embodiment, condensate K_{O} and the vapour B₁ are conducted in countercurrent to one another. In an alternative, more preferred embodiment, the condensate K_{O} is conducted at a right angle to the flow direction of the vapour B₁.

In an advantageous embodiment, the condensate K_{O}, in the rectifying section V of the column RR, is directed to the withdrawal point of the sidestream S_{K1} through at least one tray B_{O} and, at the same time, contacted with the vapour B₁ in particular in that the tray B_{O} is a sieve tray or a bubble-cap tray. Upstream and/or downstream of the conduit through the at least one tray B_{O}, the condensate K_{O} used in step (e) or the condensate K₁ obtained after step (e) can then be collected in downcomers. A corresponding apparatus is described in FIG. 3.

Alternatively, the condensate K_{O}, in the rectifying section V of the column RR, can be directed through multiple trays to the withdrawal point of the sidestream S_{K1} and, at the same time, contacted with the vapour B₁. A corresponding apparatus is described in FIG. 2.

After performance of step (e), a condensate K₁ comprising R¹OH at a temperature T_{K1} is obtained. The temperature T_{K1} is at or below the boiling temperature of the condensate under the given conditions.

Preferably, after performance of step (e), a condensate K₁ is obtained, which boils.

It is a corollary of the transfer of energy, especially heat, from the vapour B₁ to the condensate K_{O} that, in respect of the temperature T_{KO} of K_{O} and the temperature T_{K1} of K₁, T_{KO}<T_{K1}.

It is more particularly the case that T_{KO} is a temperature in the range from 1 to 30 K lower than T_{K1}, preferably in the range from 2 to 20 K lower than T_{K1}, more preferably in the range from 5 to 15 K lower than T_{K1}, yet more preferably in the range from 8 to 11 K lower than T_{K1}, most preferably 10 K lower than T_{K1}, while both K_{O} and K₁ are simultaneously in the liquid state of matter.

It is preferably the case that T_{KO} is a temperature in the range from 1 to 30 K lower than T_{K1}, preferably in the range from 2 to 20 K lower than T_{K1}, more preferably in the range from 5 to 15 K lower than T_{K1}, yet more preferably in the range from 8 to 11 K lower than T_{K1}, most preferably 10 K lower than T_{K1}, while T_{K1} corresponds to the boiling temperature of K₁, i.e. K₁ boils and, in step (f), the at least a portion of K₁ is withdrawn as liquid boiling sidestream S_{K1} from the rectifying section V below the feed of S_{KO} into RR.

### Step (f)

In step (f) of the process according to the invention, at least a portion of K₁ is withdrawn from the rectifying section V below the feed of S_{KO} into RR as liquid sidestream S_{K1}.

In step (e), accordingly, the condensate K_{O} heated in column RR is obtained as liquid sidestream S_{K1}. This liquid sidestream S_{K1} is at a temperature T_{K1} at or below the boiling temperature of the condensate K_{O}, and higher than T_{KO}. This affords a stream S_{K1} of higher energy than the 20 condensate stream S_{KO}. S_{K1} is preferably used for energy integration.

In step (f) of the process according to the invention, preferably, the at least a portion of K₁ is withdrawn from the rectifying section V below the feed of S_{KO} into RR in boiling form (i.e. as a boiling liquid sidestream S_{K1}).

S_{K1} is withdrawn from rectifying section V below the feed of S_{KO} into RR, i.e. below the point (i.e. closer to the bottom of the column RR than the point) at which S_{KO} is returned to the rectifying section V, especially to the top, of column RR in step (d).

In a particular embodiment, the withdrawal point of the liquid sidestream S_{K1} is in the rectifying section V and simultaneously in the upper half, preferably the upper third, more preferably the upper quarter, even more preferably the upper fifth, of the part of the column which is bounded at the top by the feed point for the return stream S_{KO} and at the bottom by the feed point for stream S₁.

In a further preferred embodiment, there is at least 1 theoretical plate between the feed point for the return stream S_{KO} and the withdrawal point for the liquid sidestream S_{K1}.

In a more preferred embodiment, there is 1 theoretical plate between the feed point for the return stream S_{KO} and the withdrawal point for the liquid sidestream S_{K1}.

After performance of step (f), stream S_{K1} is then obtained.

In a preferred embodiment of the present invention, in a step (g), energy is then transferred from S_{K1} to stream S₁. This transfer is especially effected by means of a heat exchanger WT for preheating of stream S₁. This further increases the energy efficiency of the process according to the invention.

In a further preferred embodiment of the present invention, in a step (g), energy is then transferred from S_{K1} to stream S₂. This transfer is especially effected by means of a heat exchanger WT for preheating of stream S₂. This further increases the energy efficiency of the process according to the invention.

The heat transferrers WT used (alternative term for “heat transferrer”=“heat exchanger”) may be the heat transferrers known to the person skilled in the art.

The process according to the invention accordingly does not give a subcooled condensate K_{O}, but rather a condensate stream S_{K1} at a temperature T_{K1} which is not only higher than T_{KO}, but can also be adjusted such that it is at the boiling point or only slightly below, i.e., for example, only 0.1 to 1.0 K below, the boiling point of the condensate K_{O} or K₁. This condensate stream S_{K1} thus has higher energy and can be used in a more versatile manner as energy source than S_{KO}.

### EXAMPLES

### Example 1 (Non-Inventive)

The construction according to Example 1 corresponds to the construction shown in FIG. 1.

A stream S₁<101> of 2.4 kg/h of a 30% by weight solution of sodium methoxide in methanol is fed to the heat transferrer WT<12> at 25° C. Stream <1052> is conducted in countercurrent to stream S₁<101> at 2.1 kg/h in heat transferrer WT<12> and hence heat is transferred from <1052> to S₁<101>. Stream S₁<101> that has been preheated to 41.5° C. is introduced via feed point <16> into the reactive distillation column RR<10>. A stream S₂<102> of 4 kg/h consisting of ethanol is fed into the bottoms circuit of the column. Column RR<10> is operated at 1 bar. A virtually methanol-free stream S_{U}<107> of 4.3 kg/h of an about 21% by weight solution of sodium ethoxide in ethanol is removed from the bottoms circuit of the column. At the top of the column, a virtually ethanol-free vapour stream S_{O}<103> of 16.1 kg/h is withdrawn and fully condensed in condenser <11>. For technical reasons, the vapour stream S_{O}<103> is subcooled to 54° C. The condensate K_{O}<105> thus obtained is divided, and a portion is fed as stream <1051> at 14 kg/h as reflux to the column at the integration point <17>. The rest of the stream <105> is fed as product stream <1052> at 2.1 kg/h to the heat transferrer WT<12> already mentioned and then leaves the process.

The subcooling by 10 K in the condenser <11> means that the stream <1052> is removed not at boiling temperature but at 54° C. In order to comply with the minimum temperature difference of 10 K required for the heat transfer, stream <1052> may be cooled only to 35° C. (the feed temperature of S₁<101> is 25° C.). It is apparent from an energy balance that, in this way, stream S₁<101> can be heated only to 41.5° C. In this example, it is thus possible to achieve a preheater output of about 31 W. The heating demand of the reboiler <13> in this case is about 5.20 kW.

### Example 2 (Inventive)

The construction according to Example 2 corresponds to the construction shown in FIG. 2 except that the apparatus <40> consists of a sieve tray which is continuous from the addition point <105> to the withdraw point <200>. This difference exists with respect to the apparatus shown in FIG. 2, which comprises four trays.

A stream S₁<101> of 2.4 kg/h of a 30% by weight solution of sodium methoxide in methanol is fed to the heat transferrer WT<12> at 25° C. Stream S_{K1}<200> is conducted in countercurrent to stream S₁<101> at 2.1 kg/h in heat transferrer WT<12> and hence heat is transferred from S_{K1}<200> to S₁<101>. Stream S₁<101> that has been preheated to 50.1° C. is introduced via feed point <16> into the reactive distillation column RR<10>. A stream S₂<102> of 4 kg/h consisting of ethanol is fed into the bottoms circuit of the column. Column RR<10> is operated at 1 bar. A virtually methanol-free stream S_{U}<107> of 4.3 kg/h of an about 21% by weight solution of sodium ethoxide in ethanol is removed from the bottoms circuit of the column. At the top of the column, a virtually ethanol-free vapour stream S_{O}<103> of 16 kg/h is withdrawn and fully condensed in condenser <11>. By comparison with Example 1, in this case, a somewhat smaller amount of vapour is required to achieve the same compositions in the product streams. For technical reasons, the vapour stream S_{O}<103> is subcooled to 54° C. The condensate K_{O}<105> thus obtained is fed completely as reflux to the column at the integration point <17>. A liquid sidestream SKi <200> is withdrawn at 2.1 kg/h at the withdrawal point <18> from the rectifying section of column RR<10> one sieve tray below the feed point <17>. Stream S_{K1}<200> is in liquid boiling form here at 64° C. and is fed to the heat transferrer WT<12> already mentioned and then leaves the process.

By comparison with Example 1, stream S_{K1}<200> is not subcooled at 54° C. but withdrawn in liquid boiling form at 64° C. With only a minimal required temperature difference of 10 K for the heat transfer, stream S_{K1}<200> may be cooled only to 35° C. (the feed temperature of S₁<101> is 25° C.). It is apparent from an energy balance that, in this way, stream S₁<101> can be heated to 50.1° C. In this Example 2, it is thus possible to achieve a preheater output of about 48 W. The heating demand of the reboiler <13> in this case is about 5.18 kW. In the inventive case according to Example 2, it is thus possible, by comparison with Example 1, to increase the heat flow transferred to stream S₁<101> by almost 60%. The required heating output in the reboiler <13> falls slightly by about 0.3%.

### Result

The procedure according to the invention affords a stream of heated condensate S_{K1}<200>, which has a higher heat output than the condensate <1052> obtained in the prior art process.

This enables more energy-efficient processes, which is apparent from the fact that the total energy requirement of the process falls, since the heat from the condensate S_{K1}<200> can be integrated into the same process or other processes in a more energy-efficient manner.

1-15. (canceled)

16. A process for preparing a compound of the formula MOR² by reactive distillation, wherein:
(a) a stream S₁ comprising a compound of the formula MOR¹ is fed via a lateral feed into a reactive distillation column RR with a rectifying section V above the feed point and a stripping section A below the feed point;
(b) a stream S₂ comprising a compound of the formula R²OH is fed into the stripping section A, the bottom and/or a bottoms circuit of the column RR,
which affords, in the stripping section A, a crude product comprising MOR², R²OH, R¹OH, and, in the rectifying section V, a vapour B₁ comprising R¹OH;
(c) a stream S_{U} of a solution of MOR² in R²OH is drawn off at the bottom of the column RR and/or from the bottoms circuit;
(d) the vapour B₁ is drawn off at the top of column RR as vapour stream S_{O} comprising R¹OH, vapour stream S_{O} is at least partly condensed, giving a condensate K_{O} at a temperature T_{KO}, and the whole condensate K_{O} is returned as reflux stream S_{KO} to the rectifying section V of column RR;
(e) in the column RR, the condensate K_{O} is contacted with the vapour B₁, such that energy is transferred from the vapour B₁ to the condensate K_{O}, which affords a condensate K₁ comprising R¹OH at a temperature T_{K1}, where T_{KO}<T_{K1};
(f) and at least a portion of K₁ is withdrawn from the rectifying section V below the feed of S_{KO} into RR as liquid sidestream S_{K1};
wherein:
M is a metal;
R¹ is an alkyl radical optionally having one or more hydroxyl groups, or a haloalkyl radical optionally having one or more hydroxyl groups;
R² is an alkyl radical optionally having one or more hydroxyl groups, or a haloalkyl radical optionally having one or more hydroxyl groups;
for R¹ and R², the carbon chain of the alkyl radical or haloalkyl radical may be interrupted by one or more oxygen atoms, wherein there are at least two carbon atoms between said oxygen atoms and any hydroxyl group of R¹ or R²;
and wherein R¹ and R² are different.

17. The process of claim 16, where M is an alkali metal.

18. The process of claim 16, wherein R¹ is methyl and R² is selected from the group consisting of: C₂ to C₁₀-alkyl, —(CH₂)₂OH, —(CH₂)₂O(CH₂)₂OH, —(CH₂)₃OH, —(CH₂)₄OH, and 1-methoxypropan-2-yl.

19. The process of claim 18, wherein R² is selected from the group consisting of: ethyl, iso-propyl, sec-butyl, 2-methyl-2-butyl, tert-butyl, 2-methyl-2-pentyl, 3-methyl-3-pentyl, 3-ethyl-3-pentyl, 2-methyl-2-hexyl, and 3-methyl-3-hexyl.

20. The process of claim 16, wherein stream S₂ in step (b) is fed in liquid form into the bottom and/or the bottoms circuit of the column.

21. The process of claim 16, wherein the proportion of all R¹OH in the solution drawn off as stream S_{U} is not more than 1.0% by weight, based on the total weight of stream S_{U}.

22. The process of claim 16, wherein the proportion of all compounds of the formula MOR² in stream S_{U} is in the range of 3% to 60% by weight, based on the total weight of stream S_{U}.

23. The process of claim 16, wherein the reactive distillation column RR has a forced-circulation evaporator and stream S₂ is fed in liquid form into the feed to the forced-circulation evaporator.

24. The process of claim 16, wherein the proportion of all R²OH in the condensate K₁ is not more than 1.0% by weight, based on the total weight of K₁.

25. The process of claim 16, wherein stream S₁ comprises a solution of compound MOR¹ in R¹OH and the solution comprises 10% to 40% by weight of MOR¹, based on the total weight of stream S₁.

26. The process of claim 16, wherein, in an additional step (g), energy is transferred from S_{K1} to stream S₁ and/or stream S₂.

27. The process of claim 16, wherein, in step (d), the whole condensate K_{O} is returned as reflux stream S_{KO} to the top of column RR.

28. The process of claim 16, wherein the proportion of all compounds R²OH in stream S₁ is <10% by weight, based on the total weight of stream S₁.

29. The process of claim 16, wherein, in step (f), the at least a portion of K₁ is withdrawn from the rectifying section V below the feed of S_{KO} into RR as liquid boiling sidestream S_{K1}.

30. The process of claim 29, wherein T_{KO} is a temperature in the range of from 1 to 30 K lower than T_{K1}.

31. The process of claim 17, wherein R¹ is methyl and R² is selected from the group consisting of: C₂ to C₁₀-alkyl, —(CH₂)₂OH, —(CH₂)₂O(CH₂)₂OH, —(CH₂)₃OH, —(CH₂)₄OH, 1-methoxypropan-2-yl.

32. The process of claim 31, wherein R² is selected from the group consisting of: ethyl, iso-propyl, sec-butyl, 2-methyl-2-butyl, tert-butyl, 2-methyl-2-pentyl, 3-methyl-3-pentyl, 3-ethyl-3-pentyl, 2-methyl-2-hexyl, and 3-methyl-3-hexyl.

33. The process of claim 32, wherein stream S₂ in step (b) is fed in liquid form into the bottom and/or the bottoms circuit of the column.

34. The process of claim 33, wherein the proportion of all compounds R¹OH in the solution drawn off as stream S_{U} is not more than 1.0% by weight, based on the total weight of stream S_{U}.

35. The process according of claim 34, wherein the proportion of all compounds of the formula MOR² in stream S_{U} is in the range of 3% to 60% by weight, based on the total weight of stream S_{U}.
